(19) United States
(12) Patent Application Publication
(10) Pub. No.: US 2015/0310377 A1
(43) Pub. Date: Oct. 29, 2015

(54) METHODS, DEVICES AND SYSTEMS FOR PROVIDING ONLINE CUSTOMER SERVICE

(71) Applicant: VIDEODESK SA, Paris (FR)

(72) Inventors: Igor SCHLUMBERGER, Paris (FR); David LEBOIS, Paris (FR); Guillaume SALOMON, Versailles (FR); Cyrille DUVAL, Issy les Moulineaux (FR); Olivier COSTE, Garches (FR)

(73) Assignee: VIDEODESK SA, Paris (FR)

(21) Appl. No.: 14/261,127

(22) Filed: Apr. 24, 2014

(51) Int. Cl. G06Q 10/06; G06Q 30/00

(52) U.S. Cl. CPC G06Q 10/063114; G06Q 30/016

(57) ABSTRACT

A method may comprise determining whether a customer service representative is available now for an online communication session over a computer network with a customer browsing a webpage of a website: causing a customer service availability notification to display on the webpage of the website browsed by the customer, the customer service availability notification being configured to identify at least the customer service representative that is available now and modes of communication with which the customer may communicate with the identified customer service representative; receiving, over the computer network, an indication that the customer desires to enter into the online communication session with the identified customer service representative and a selection of a desired one of a plurality of available modes of communication: and upon receiving the indication from the customer, initiating the online communication session with the identified customer service representative using the selected mode of communication.

### BACKGROUND

Today's online customers have virtually unlimited information at their fingertips. As a result, impulse purchasing is trending downward. Indeed, customers typically do not hesitate to visit multiple websites on multiple devices to find what they are looking for before committing to a purchase. As a result, it is becoming increasingly complicated for online vendors to close the deal and make the sale. As a consequence, many online retailers find that the process of acquiring and retaining customers is becoming progressively more costly.

According to studies, more than half of all customers will abandon an online purchase if they cannot find an answer to their question. Significantly, almost three quarters of online shoppers have indicated that valuing their time is the most important thing an online business can do to provide good customer service.

### BRIEF DESCRIPTION OF THE DRAWINGS

FIG. 1 shows aspects of one embodiment.

FIG. 2 shows further aspects of one embodiment.

FIG. 3 includes a flowchart of a method according to one embodiment.

FIG. 4 includes another flowchart of a method according to one embodiment.

FIG. 5 is a diagram showing additional aspects of one embodiment.

FIG. 6 is a diagram showing further aspects of one embodiment.

FIG. 7 is a diagram showing still further aspects of one embodiment.

FIG. 8 is a diagram showing yet further aspects of one embodiment.

FIG. 9 is a diagram showing other aspects of one embodiment.

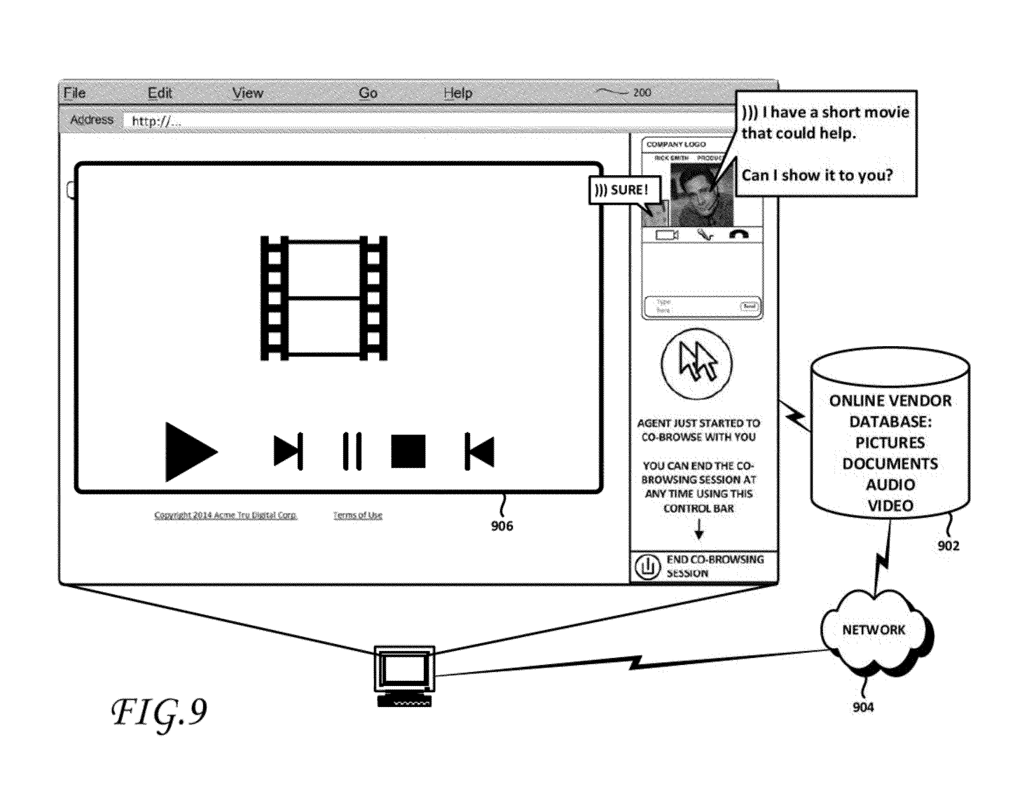

FIG. 10 is a diagram showing still other aspects of one embodiment.

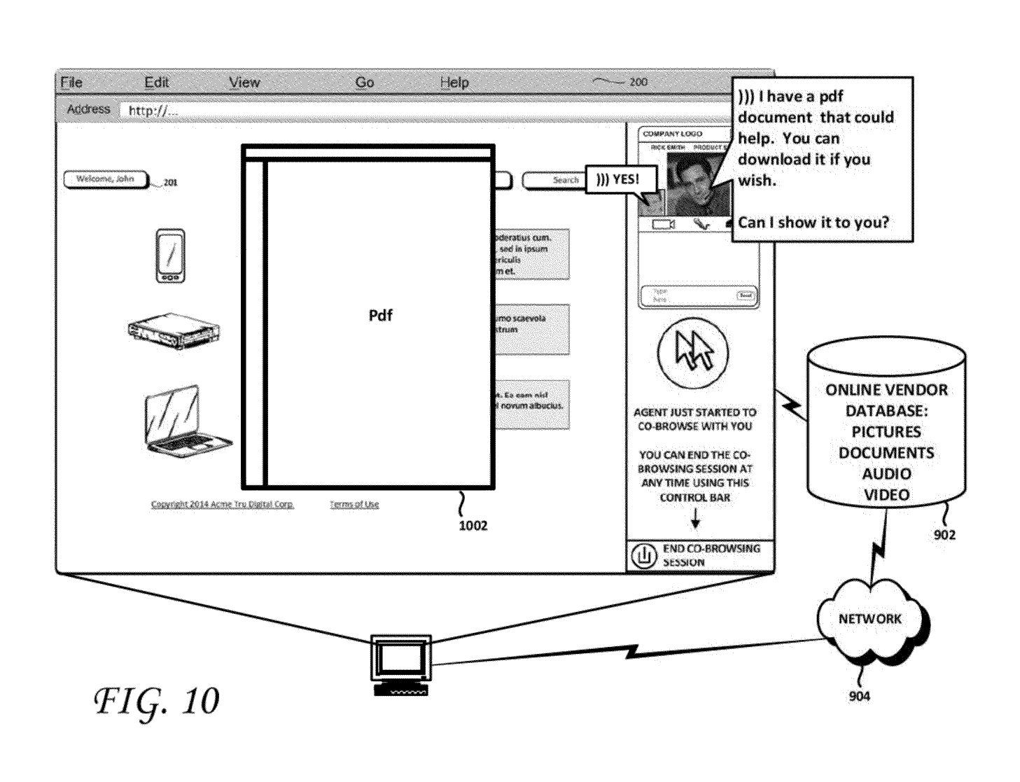

FIG. 11 is a diagram showing still other aspects of one embodiment.

FIG. 12 is a flowchart of a method according to one embodiment.

### DETAILED DESCRIPTION

Disclosed herein are embodiments that allow any customer on an e-commerce website to initiate a video, audio and/or text chat conference with a live sales representative directly and with immediacy, as if they were shopping in a brick and mortar store. This online, live and personal customer service may be made available with a single click, and provides the shopper with human advice and real-time support during their visit to the website, without delay, without downloading an application and without pre-registration. The immediacy and the intimacy made possible by such a face-to-face interaction with a live person brings the online experience as close as possible to the customer's experience had he or she visited a brick and mortar store and been provided with the assistance of a knowledgeable, personable sales clerk.

According to one embodiment, virtual conferencing software allows individuals to participate in not only in online text chats, but also in live audio and video conversations directly on any website, without requiring the web-user to download additional software or to create or sign-in to a user account. To enable this functionality, one embodiment adds a short script to the merchant website. As a result Internet shoppers may use their web browser to connect with a live agent on a specific website and receive assistance at the click of a button. The availability of a live agent provides a pleasant, non-intrusive experience for web visitors. Customer can privately browse a website at their leisure with the peace of mind engendered by the knowledge they are but one step away from personal, live and immediate assistance should it be required.

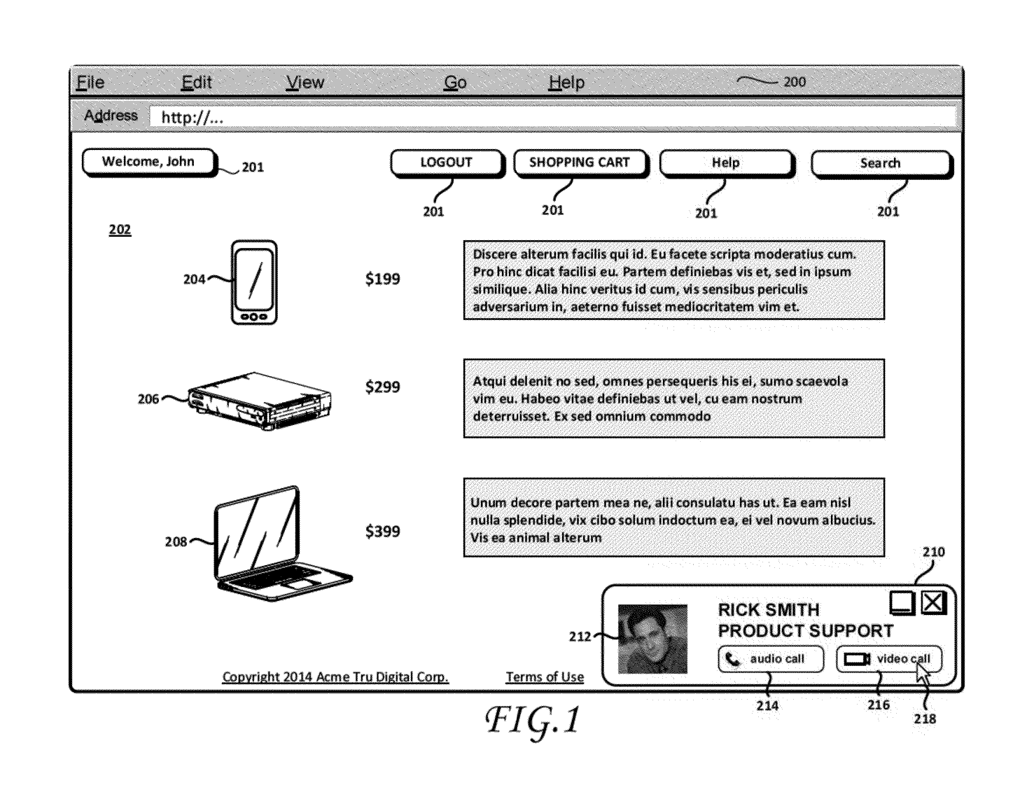

FIG. 1 shows an illustrative and exemplary website configured according to one embodiment. As shown, a browser 200 may comprise a plurality of message and navigation buttons (or other user interface devices) 201. The website 202, in this case that of an electronic retailer, may be configured to showcase a number of products such as a mobile device 204, a digital video recorder (DVR) 206 and a laptop computer 208, for example. The price and the description of each may also be provided, as shown. According to one embodiment, a customer service availability notification 210 may also be provided. As shown, the customer service availability notification 210 may comprise, according to one embodiment, a photo 212 of the customer service representative, as well as his or her name and title. Customer-selectable buttons may also be provided, enabling the user to select the desired mode of communication and to initiate an audio-only call to the customer service representative as shown at 214 or to initiate a full, live, two-way video call with customer service representative, as shown at 216.

According to one embodiment, to initiate a communication session with a customer service representative, the customer need only carry out a single click. Such functionality, according to one embodiment, may be embedded into the code of the online vendor's website 200. The functionality may be integrated into a store website using HTML markup and application program interfaces (APIs) may be provided to enable the integration thereof over enterprise systems. According to one embodiment, a short client-side script such as, for example, a JavaScript <script> tag may be to be added to the code of any webpage that would benefit from the presence of a live agent. According to one implementation of one embodiment, the script may be written in JavaScript and may take the form of, for example (using the assignee “videodesk” string for exemplary purposes only):

<script
type=“text/javascript”>

var _videodesk= _videodesk ∥ { };
_videodesk[‘firstname’] = ‘’ ;
_videodesk[‘lastname’] = ‘’ ;
_videodesk[‘company’] = ‘’ ;
_videodesk[‘email’] = ‘’ ;
_videodesk[‘phone’] = ‘’ ;
_videodesk[‘customer_lang’] = ‘’ ;
_videodesk[‘customer_id’] = ‘’ ;
_videodesk[‘customer_url’] = ‘’ ;
_videodesk[‘cart_id’] = ‘’ ;
_videodesk[‘cart_url’] = ‘’ ;
_videodesk[‘order_id’] = ‘’ :
_videodesk[‘order_url’] = ‘’ ;
_videodesk[‘uid’] = ‘62c3a6a87085e72714e8d3fa502c8bf9’ ;
_videodesk[‘lang’] = ‘en’ ;

(funtion( ) {
var videodesk = document.createElement(‘script’); videodesk.type =

‘text/javascript’; videodesk.async = true:

videodesk.src = {‘https:’ == document.location.protocol ? ‘https://’ :
‘http://’) +

module-videodesk-com/js/videodesk.js’;

var s = document.getElementsByTagName(‘script’)[0];

s.parentNode.insertBefore(videodesk, s);

})( );

</script>

At the outset, a script element is created:

var videodesk=document.createElement(‘script’);

The next item is created with different attributes (e.g., a script that uses, in one implementation, javascript with async such that it does not affect loading other elements in the web page). In one implementation, several src protocols may be used, such as https first and then http:

videodesk.type = ‘text/javascript’; videodesk.async = true;
videodesk.src = (‘https:’ == document.location.protocol ? ‘https://’ :
‘http://’)

Thereafter, a URL calls a videodesk script (videodesk.js) and allows the the element (var s) to be constructed, which will be displayed on the web page (insertBefore):

‘module-videodesk.com/js/videodesk.js’;

var s=document.getElementsByTagName(‘script’)[0]; s.parentNode.insertBefore(videodesk, s);

It is to be understood that the script above is provided only for exemplary purposes and that the script may be differently configured, as those of skill in this art may appreciate.

A Customer Relationship Management (CRM) software may be used to populate at least some of the requisite fields (firstname, lastname . . . ). The _videodesk[‘uid’] variable is a unique number that identifies the particular website on which the script is active and the _videodesk[‘lang’]=‘en’ variable is a variable that identifies the language of the user interface seen by the online customer (in this case, English).

According to one embodiment, the website 202 may be configured to show the customer whether a customer service representative is currently, immediately available. For example, in FIG. 1, the customer service availability notification 210 may be configured to appear to the customer on the online vendor's website 202 only when the or a customer service representative is immediately available. According to one embodiment, if no customer service representative is currently available, the average wait time may be displayed and/or other actions may be taken to inform or otherwise distract the customer until a customer service representative is, in fact, available. In the illustrative example shown in FIG. 1, a customer service availability notification 210 has appeared, notifying that Rick Smith, product support specialist, is immediately available, live and in person, to the customer, should he or she desire to initiate a communication session via, for example an audio call 214 or a video call 216. According to one embodiment, the customer service availability notification 210 or other user interface notification device may be configured to display the name, title and picture of the real agent that is available for the customer to contact now. In contrast, conventional solutions offer only an anonymous mode comprising, for example, a “Contact Us” message that is similar to (and just as impersonal) as an 800 number. It is believed that customer appreciate knowing who they will be conversing with and what they look like—in the same manner as a face-to-face meeting between a customer and a customer service representative in a high-end boutique. It has been found that the click ratio is much higher with such a personalized mode, as compared to more anonymous interactions. Referring back to the example being developed in FIG. 1, had Rick Smith not been available for immediate assistance, his corresponding customer service availability notification 210 would not have appeared to the customer on the vendor's website 202. According to one embodiment, the communications modalities available to the customer with any particular customer service representative may be made apparent on the customer service availability notification 210. In the exemplary FIG. 1, the customer service representative Rick Smith is available via an audio call 214 or a video call 216. Rick Smith may not have enabled the text chat button on his customer service availability notification 210 because he may currently suffer from a sprained wrist, for example and may be unable to type at the present time. As shown at 218, the customer may have decided to initiate a video session with the customer service representative and has, in this instance, clicked the video call button 216, as shown at 218.

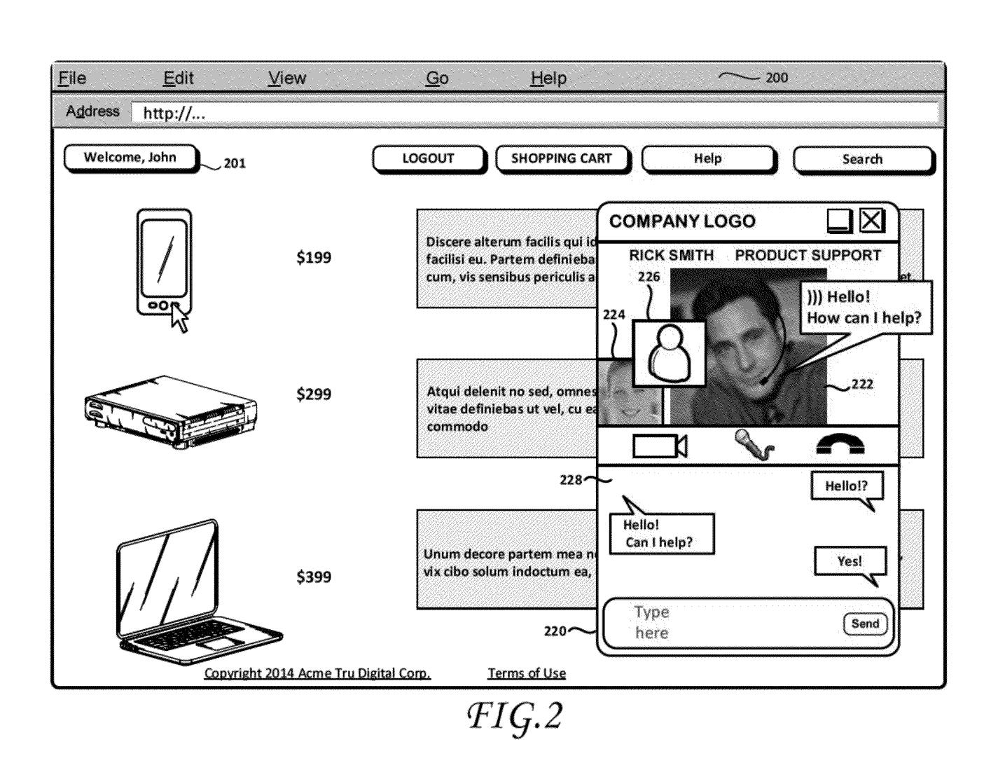

As shown in FIG. 2, a session dialog window 220 may appear after the customer has initiated a communication session. In the example being developed herewith, the customer has decided to initiate a video session with Rick Smith. A video stream showing a live image of Rick Smith may then be generated and streamed to the session dialog window 220, as shown at 222. The customer is now in full real time, duplex communication with the customer service representative Rick Smith. For example, the customer service representative may say “Hello! How can I help”, or some other greeting, and his voice is reproduced at the customer end through the speakers of the accessing client-side device. If the customer has enabled his or her webcam, a stream showing the customer may be provided to the customer service representative and reproduced in a smaller window 224 within session dialog window 220. If the customer does not feel comfortable showing his or her face to the customer service representative, or she may be represented by an avatar or some generic customer representation, as shown at 226. The customer may respond to the customer service representative by speaking into his or her webcam and/or may type his or her responses in the text chat portion of the session dialog window 220. In this manner, the customer service representative and the customer may engage in a real time, live conversation by which the customer service representative may address all of the customer's questions and concerns relative to the goods and services offered at the vendor's website.

According to one embodiment, the customer may be tracked as he or she traverses the online vendor's website. Thereafter, the customer service representative may be provided with information detailing the customer's precise path thought the website before engaging with the customer service representative. For example, the customer service representative may be provided with information including the page and the amount of time spent by the customer on each. This information may be useful to the customer service representative, as it may provide insight into the customer's intentions. Such information may also enable the customer service representative to further personalize the customer's experience as he or she navigates the vendor's online store.

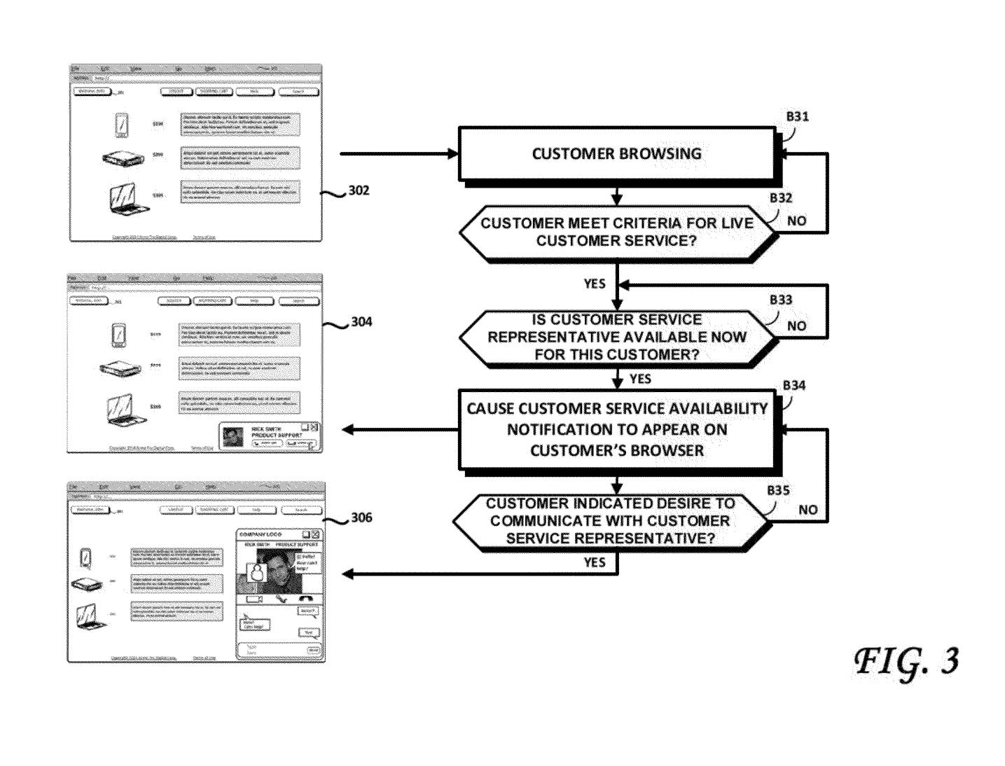

FIG. 3 is a hybrid flowchart of a method according to one embodiment. As shown therein, block B31 calls for a determination, by the vendor, that a customer is browsing on their website 302. At B32, it may be determined whether the customer (whether browsing anonymously or as a previously logged in customer) meets predetermined criteria (if any) for live customer service. For example, such predetermined criteria (which need not be static and may be dynamic depending upon prevailing conditions) may include, for example:
the amount of time that the user has been reading the help section of the website;
the classification (e.g., bronze, Silver, Gold, platinum) of the customer;
the amount of money the customer is likely to spend based upon his or her interest in specific products and/or services;
The general geographical location of the customer's accessing device based, for example, on zip codes, geo-location and/or IP address.

Other criteria may be devised in addition to or in place of the foregoing to determine whether a customer should be provided with the opportunity to converse with a live agent. Returning now back to FIG. 3, if the customer does not meet the criteria for live customer service (NO branch of B32), the method may revert back to B31. If, however, the customer does, for whatever reason, meet the criteria for live customer service (YES branch of B32), it may be determined whether one or more customer service representatives are available now for this customer. If no customer service representatives are available (NO branch of B33), the method loops while waiting for one to become available. If, however, a customer service representative is immediately available for this customer (YES branch of B33), then a customer availability notification may be displayed on the user's browser at B34 as shown at 304, in an unused portion thereof or overlaid onto the webpage. If, as shown at the YES branch of B35, the customer has indicated a desire to communicate with a customer service representative (or with Rick Smith in particular, the customer service representative identified and shown on the customer availability notification 210 in this example), a communication session window may be displayed onto the currently viewed webpage, as shown at 306. The customer service representative may then greet the customer and address their questions and/or requests.

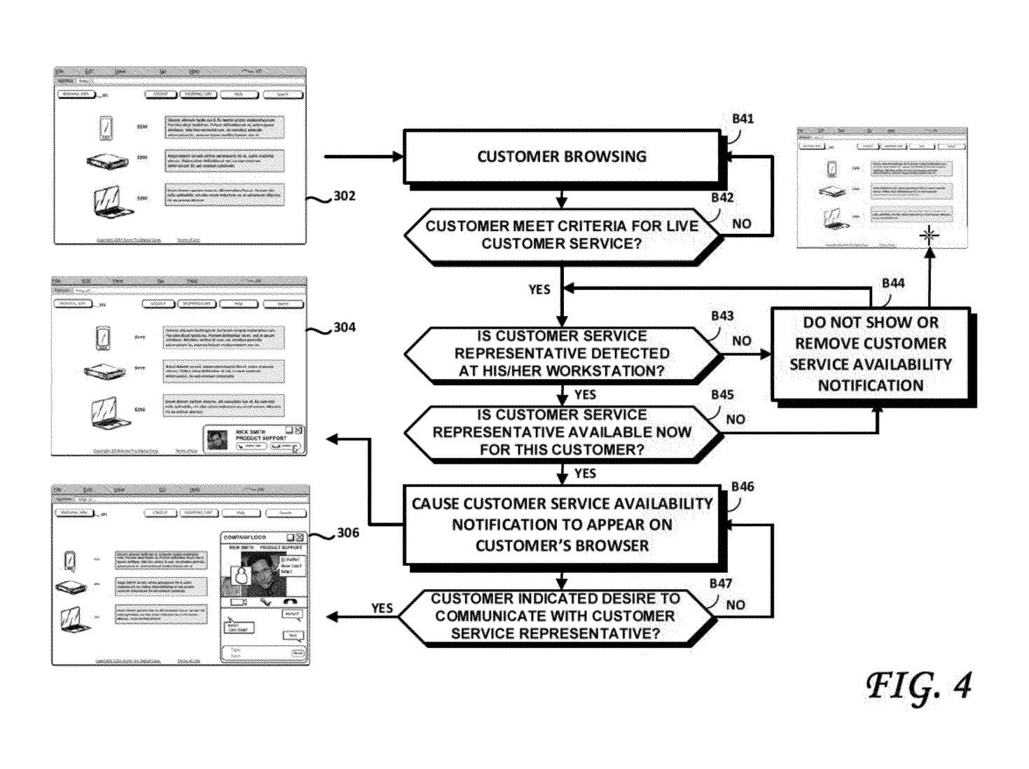

FIG. 4 is another hybrid flowchart of a method according to one embodiment. As shown therein, block B41 calls for a determination, by the vendor, that a customer is browsing on their website 302. At B42, it may be determined whether the customer (whether browsing anonymously or as a previously logged in customer) meets the above-described predetermined criteria for live customer service. If the customer does meet these criteria, one embodiment calls for the detection, at the customer service representative workstation, of the presence or absence of the customer service representative. For example, the output of the customer service representative's webcam may be analyzed and image/video recognition software may be employed to determine whether, in fact, the customer service representative is, in fact, present at or sitting in his or her workstation and is ready to assist the customer. Other methods of detecting the presence or absence of the customer service representative may be employed without departing from the scope of the present disclosure. For example, Radio Frequency Identification (RFID) technologies or other Near Field Communications (NFC) protocols may be used to determine whether the customer service representative is actually present and ready to assist the customer. For example, the customer service representative may have stepped out to refill his coffee or use the restroom.

If the customer service representative is not, in fact, detected to be physically present at his or her workstation (NO branch of B43), the corresponding customer service availability notification 210 is either removed from the customer's view of the vendor's website or not shown in the first place. This ensures that when the customer does choose to initiate a communication session with a customer service representative, that that customer service representative is actually available and is ready and able to engage with the customer without delay, and without placing the customer in a queue (thereby avoiding annoying messages of the type “A customer service representative will be available to assist you in about 10 minutes”). Assuming that the customer service representative is indeed available for an immediate near immediate communication session with the customer as shown by the YES branch of B45, then a customer availability notification 210 may be displayed on the user's browser at B46 as shown at 304, in an unused portion thereof or overlaid onto the webpage. If as shown at the YES branch of B47, the customer has indicated a desire to communicate with a customer service representative (or with Rick Smith in particular, the customer service representative identified and shown on the customer availability notification in this example), a communication session window may be displayed onto the currently viewed webpage, whereupon the customer service representative may greet the customer and address their questions and/or requests, as shown at 306. If no such indication is received from the customer, the method may revert back to B46.

In this manner, the customer service representative need to remember to change his or her availability status each time he or she gets up to stretch their legs or takes a break. Conversely, the customer is never kept waiting for an absent customer service representative whose customer service availability notification incorrectly indicates that he or she is present and ready to assist the customer.

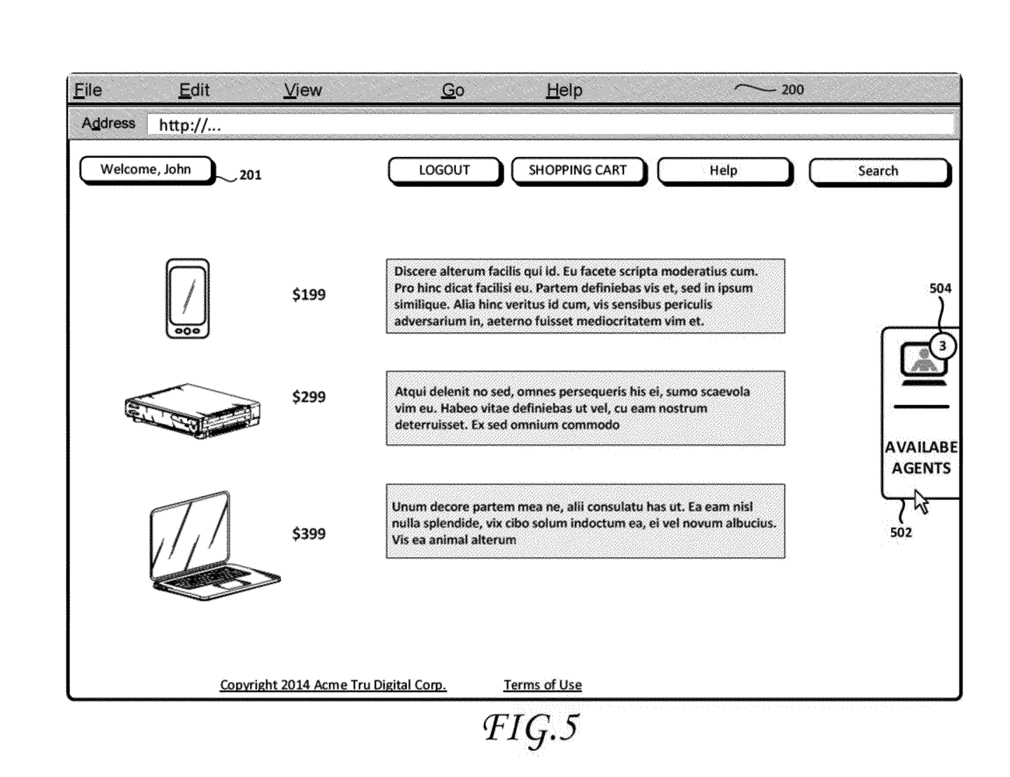

As shown in FIG. 5, the customer availability notifications may be made to be relatively unobtrusive. Indeed, a discrete customer availability notification, in the form of a small tab on the side of the customer's currently displayed webpage, may be generated, as shown at 502. Such a customer availability notification may indicate, according to one embodiment, the number of customer service representatives who may be available and standing by to assist the customer. In the illustrative example of FIG. 5, three such customer service representatives are shown to be currently available, as shown at 504.

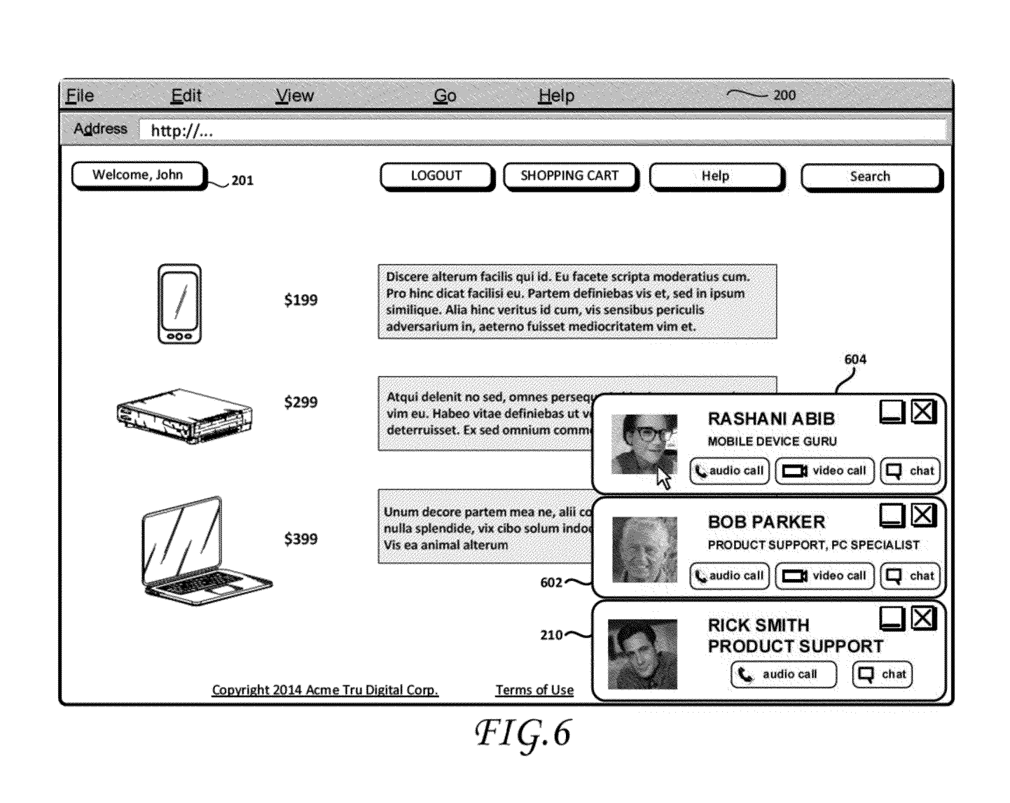

In FIG. 5, the customer has clicked or otherwise selected the tab 502 indicating that three customer service representatives are currently available, as indicated at 304. FIG. 6 shows one possible implementation of the resulting display on the customer's currently displayed webpage as a result of the customer's selection of the tab 502. As shown therein, the three customer service representatives previously indicated to be available are shown, each in respective customer service availability notifications 210, 602 and 604. Each may include the photo of the customer service representative, the communications modalities with which the customer may communicate with them (e.g., audio, video or text chat) and their specialties, if any or other relevant information. Although not shown, other characteristics of the customer service representatives may be shown, such as language fluencies and the like. The customer may then select the available customer service representative with whom he or she wishes to enter in video/audio or chat conference. This decision may be based upon the stated expertise of the customer service representative, the gender or appearance of the customer service representative or upon any other reason(s), whether objective or subjective.

The resulting session, whether video, text chat or audio only, may be configured to begin within less than, for example, 15 seconds from the time that the customer clicks or otherwise indicates his or her desire to enter into a communication session with the or a selected customer service representative. The resultant session may be conformed to the screen resolution, refresh rate and the like of the session-requesting device, whether such device is a desktop computer, a laptop, a tablet or other mobile device.

According to one embodiment, the customer service representative and the customer may communicate via text chat only, text chat with live audio and/or text chat with live audio/video. Real-time, high quality web audio and/or video communication may be made available between the customer service representative and the customer. Such audio/video communication may be made available for all browsers and various operating systems and tablets. According to one embodiment, in the case in which the web-user selects an audio or a video call, the web-user may be initially prompted to authorize or deny access to their computer's microphone and/or webcam, whereupon the customer service representative/agent may then be presented with a communication request corresponding to the medium selected by the customer. According to one embodiment, either or both the customer and the customer service representative may text chat while in a video chat session. The video chat session may proceed even if the user does not have a microphone, has a non-operative microphone or has decided to turn outgoing audio off. In that case, the customer service representative would appear on video and be heard by the customer, while the customer would communicate back via text chat. One embodiment allows the customer—customer service representative pair to smoothly transition from a text-only session to an audio or video chat session. Indeed, at the launch of a text chat session, it may be determined whether the configuration of both parties enables audio and/or video chatting. Such configuration may include, for example, the hardware and software on both sides of the exchange, as well as the availability level of the customer service representative. According to one embodiment, either the customer service representative or the customer may propose to the other to switch communication modes such as from text to audio or to video or from video only to full duplex video. Indeed, customers may be self-conscious at the beginning of a communication session and elect to initially communicate only via text. As their comfort level increases, they may decide to try an audio or video exchange. Moreover, a customer service representative may use his or her discretion or intuition and invite selected customers to move from a text-only communication session to an audio or video communication session. The transition between communication modes may be made seamlessly on both sides, and need not require any new device, web page or indeed any action on the part of the customer. A record or transcript of the entire session, across communication modes, may be generated and archived as desired.

The multi-mode communication capabilities of embodiments may be leveraged to good advantage. For example, customer may see and hear the agent via a one-way video feed while the customer only communicates with the customer service representative by texting. Indeed, the visitor may not want to be seen (at home) or heard (at work) and may, therefore, prefer to text. However, as the agent may be heard and/or seen by the customer, an increased level of intimacy between the parties to the communication is nevertheless achieved. Such an asymmetrical mode of communication is a convenient and non-threatening way to initiate a conversation and may, eventually, lead seamlessly to a full two-way video conversation, if the customer's comfort level so allows. The transition from text-only to audio or full video may be made effortlessly from the customer's point of view, thereby enhancing customer satisfaction and engagement which, in turn, yields a higher “just browsing”-to-purchase conversion rate.

According to one embodiment, the customer's configuration (including both hardware and software) may be detected prior to proposing any communication format such as, for example, full duplex video, audio only text only, one way video and/or combinations thereof. Indeed, the detected configuration may drive the proposed communication format and communication may only be proposed with the customer if such is indeed feasible. For example, if the OS does not allow audio or video chat (such as iOS, for example), only text-based user interface elements may be displayed (i.e., no audio or video call buttons may be displayed). According to further embodiments, if no microphone is detected on the customer's accessing device, no audio call may be proposed, only text. Moreover, depending on the detected version of the customer's browser, different selected communication protocols may be employed (e.g., Flash on IE and Safari, or older versions of Chrome or Firefox, WebRTC on recent versions (as of this writing) of Chrome and Safari). Accordingly, the customer is not presented with the option of communicating with a customer service representative in a manner that is not feasible in his or her hardware or software environment, thereby managing the customer's expectations.

According to one embodiment, the webpage currently displayed to the customer need not be obscured, as the video session may be rendered in a separate frame. Alternatively, the video chat session may simply overlay all or a part of the webpage displayed to the customer. The customer may be provided with a significant degree of control over the communication session, in that he or she may always have access to a button that would sever the link between the customer and the customer service representative. Also, the customer, according to one embodiment, may be provided with the ability to re-size or minimize the frame or window within which the customer and the customer service representative are communicating. Moreover, the session communication window 220 and/or other user interface devices may be customized by the vendor to include their color scheme or logo, thereby seamlessly incorporating this functionality into the look-and-feel of the vendor's website. The customer may also be provided with some customization options.

According to one embodiment, a one-way video capability may be implemented. For example, the customer service representative may be enabled to only hear the voice of the customer, but not a live video feed thereof. In this scenario, the agent may, according to one embodiment, be seen and heard by the customer. This provides complete privacy for the customer who may not, for any reason, want to be seen by the customer service representative. For example, the customer may be at home or may be uncomfortable with appearing on camera. The one-way communication mode may, however, present challenges as the customer service representative no longer has the ability to leverage non-verbal cues that would otherwise be apparent to the customer service representative in a two-way video experience.

According to one embodiment, the application enabling the functionality shown and described herein may be configured to detect and monitor the bandwidth available between the customer's accessing device and the servers to which the application communicates.

According to one embodiment, the quality (e.g., resolution, frame rate, etc.) of the video session may be reduced upon detection of dropped packets that are indicative of a poor quality communication channel or insufficient bandwidth to support the current video quality. As a result, the communication session may be automatically downgraded to an audio-only session or text-only session as needed, if the bandwidth detected drops below predetermined static or dynamically determined thresholds. According to embodiments, the best possible video and audio quality may be ensured for every call by altering the video quality based on, for example, the device (e.g.: CPU, OS), network conditions (e.g.: bandwidth, latency, packet loss) and automatically selecting the best or appropriate communication protocol (such as WebRTC P2P, Flash RTMP and the like). Audio quality may be advantageously set to be at least equivalent to a standard cell phone quality of service. The bandwidth for full duplex video chat may be capped at some predetermined maximum such as, for example, 600 kbps. Moreover, during video communication session, any occasional video freeze should be undetectable by the customer, or quickly resolved.

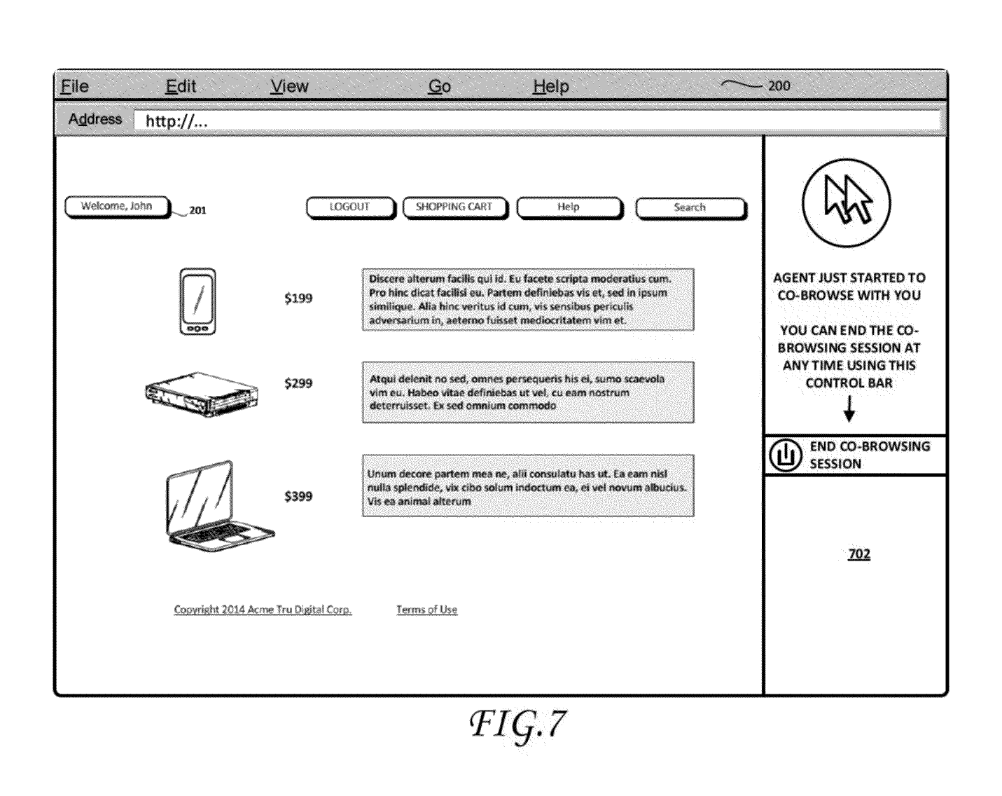

According to one embodiment, the customer and the customer service representative may agree to enable a co-browsing session. FIG. 7 shows a webpage configured for a co-browsing session between a customer and a customer service representative, according to one embodiment. Co-browsing between the online customer and the customer service representative enables the customer service representative to direct the customer verbally through a website or to conversationally describe a product or service available for sale on the website. Upon receiving authorization to do so, the customer service representative may be granted full control of the pointing device to navigate the site. Actions may be taken to ensure that the customer is made aware that a co-browse session has begun. For example, the customer may be required to make an affirmative declaration and/or take specific actions before a co-browsing session may be initiated. Moreover, the customer may be provided, in a text chat section for example, with a link to the online store's privacy policy. According to one embodiment, the customer service representative need not require any action (i.e., no authorization, no acceptance, no click) on the part of the customer to launch a co-browsing session. This is may be advantageous in some situations as the customer may, at times, misunderstand instructions or confuse one button for another. According to such an embodiment, as soon as the customer has launched a call, he or she may be directly helped by the customer service representative without any further action on his or her side. Such a seamless integration of co-browsing within a chat session enhances the utility and access of the communication session between the customer and the customer service representative. Although a co-browsing session may be launched without further action on the customer's part, it may be prudent to obtain the customer's explicit authorization before taking control of the page or accessing any other functionality or files on the customer's computer.

As shown in FIG. 7, a separate frame 702 may be generated and rendered by the customer's browser on the webpage currently being viewed by the customer. This separate frame, window or other user interface device should provide clear visual cues and indicia that are indicative of a co-browsing session, to both the customer and the customer service representative. According to one embodiment, the co-browsing session should allow redirection back and forth to other websites such as, for example, the websites of other vendors, agencies or entities. According to one embodiment, the customer service representative may have or be granted the ability to add products or services to the customer's online shopping cart. According to one embodiment, both the customer and the customer service representative may be provided with the ability to control the browsing at any time, including the option to terminate the co-browsing session.

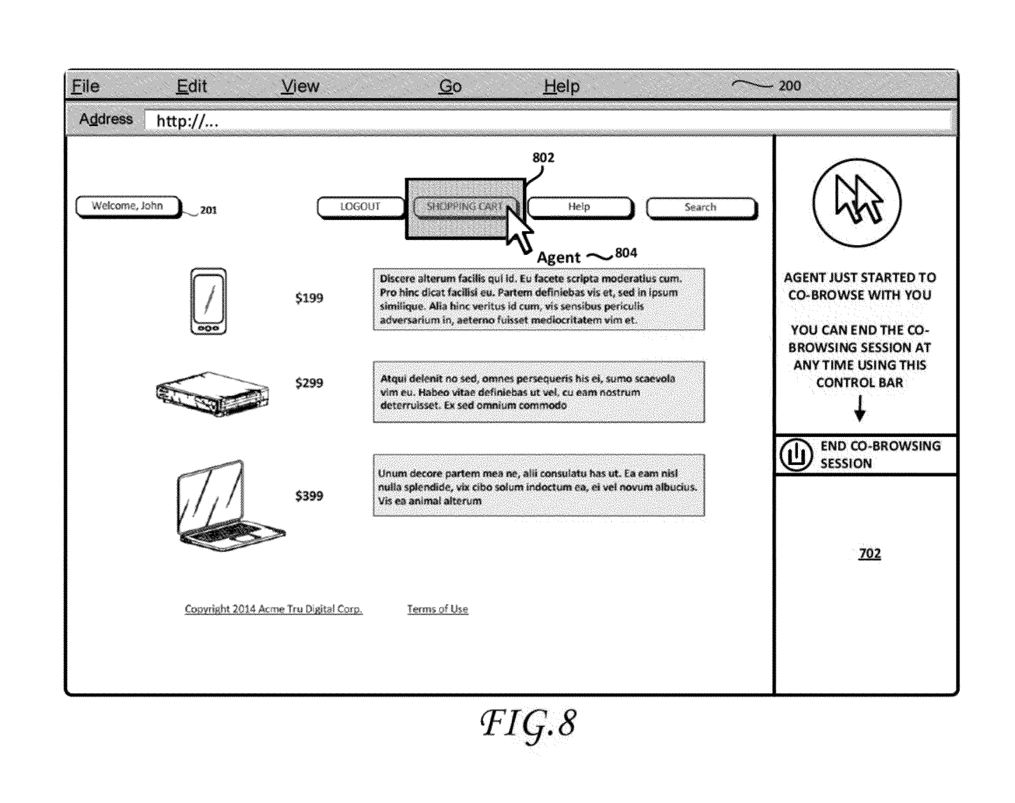

According to one embodiment, co-browsing sessions may have different characteristics and formats. In a first format, the co-browsing session is a customer-controlled co-browsing session, which may also be called a “Highlight Mode”. In Highlight Mode, some features of which are shown in FIG. 8, the customer service representative may be provided with the ability to point and click on specific areas shown on the customer's browser. These specific areas pointed to by the customer service representative may then, according to one embodiment, become highlighted on the customer's browser, as shown at 802 in which the customer service representative has caused the “Shopping Cart” button portion of the webpage to become highlighted. This enables the customer service representative to help the customer to navigate the site by showing them where they should click their pointing device. This allows the customer to maintain complete control over the navigation process while receiving live and helpful direction from the customer service representative, which ultimately enhances the online store's accessibility. To differentiate the customer service representative's cursor from the customer's cursor and to help dispel any confusion experience by the customer during a co-browsing session, the customer service representative's cursor may be shaped or sized differently from the customer's. As shown at 804, the customer service representative's pointer may be sized and shaped similarly to the customer's pointer, but be conspicuously labeled with an indicator such as, for example, “Agent”.

A second co-browsing format may be provided, according to one embodiment, in which the customer service representative controls the co-browsing session. This co-browsing mode may be termed “Control Mode”. In Control-Mode, the customer service representative controls navigation, subject to a prior and specific authorization by the online customer. The customer may then observe and learn from the actions of the customer service representative. In whichever mode, the customer may end the co-browsing session at any time.

According to further embodiments, the customer service representative may be provided with the ability to, for example and without limitation:
change the highlight color;
to create a window around the co-browse session for complete transparency to the customer of exactly what is shared during the co-browsing session;
disclose in a text chat section that a co-browsing session has begun;
increase or decrease the size of the pointer;
mask confidential fields;
enter data on behalf of the customer; and
navigate through different pages of the website.

According to one embodiment, a screen sharing functionality may be provided, whereby the customer service representative shares all or part of their screen, specific operating systems (e.g., Windows or iOS) functions or other functionality of the vendor's website. According to one embodiment, the customer service representative may restrict parts of their screen, which will not be shared with customer. In screen-sharing mode, only pre-selected zones of the customer service representative's screen may be shown to the customer. In screen-sharing mode, the customer service representative's annotations, marks and highlights should be readily apparent and clear to the customer. In this mode, the customer should only be able to see what the customer service representative intends to be shared, to the exclusion of anything else on the customer service representative's screen, such as dashboard, other windows, frames and the like.

The customer service representative, according to one embodiment, may have access, over a network 904 (including, for example, the Internet) to a database 902 that stores a media library from which the customer service representative may select items to be pushed to or otherwise made available to the customer during the co-browsing or screen-sharing session. The database 902, for example, may comprise pictures, documents, audio and/or videos that may be pushed to or otherwise shared with the customer during a co-browsing or screen-sharing session. Using such a database 902, the customer service representative has the ability to share pre-recorded and canned video 906 (e.g., video demonstrations and the like) with the customer with the click of the mouse. The customer service representative, in this manner, may remain aware of the customer's position while watching the video, which allows the customer service representative to be prepared to continue the conversation when the video concludes or when the customer has a question in while the video is playing or has been paused. Basic video control functionality may be provided to both the customer service representative and the customer such as play, stop, pause, fast-forward, and rewind. Similar functionality may be employed to enable an introductory video to be retrieved from the media database 902 and played for the customer while the customer, for example, waits for a customer service representative to become available. According to one embodiment, the customer may resize the video window 906, maximize the window or minimize it, at will. A link to the video may then be provided to the customer after the communication session with the customer service representative has ended.

The media library in the database 902 may also, according to one embodiment, be leveraged by the customer service representative to enable sharing of documents (pdf documents, for example) 1002 with the customer, who may be provided with the opportunity to save it to their desktop for later reference. Advantageously, user manuals or comparison charts may be provided by the customer service representative in this manner and optionally saved by the customer for further review.

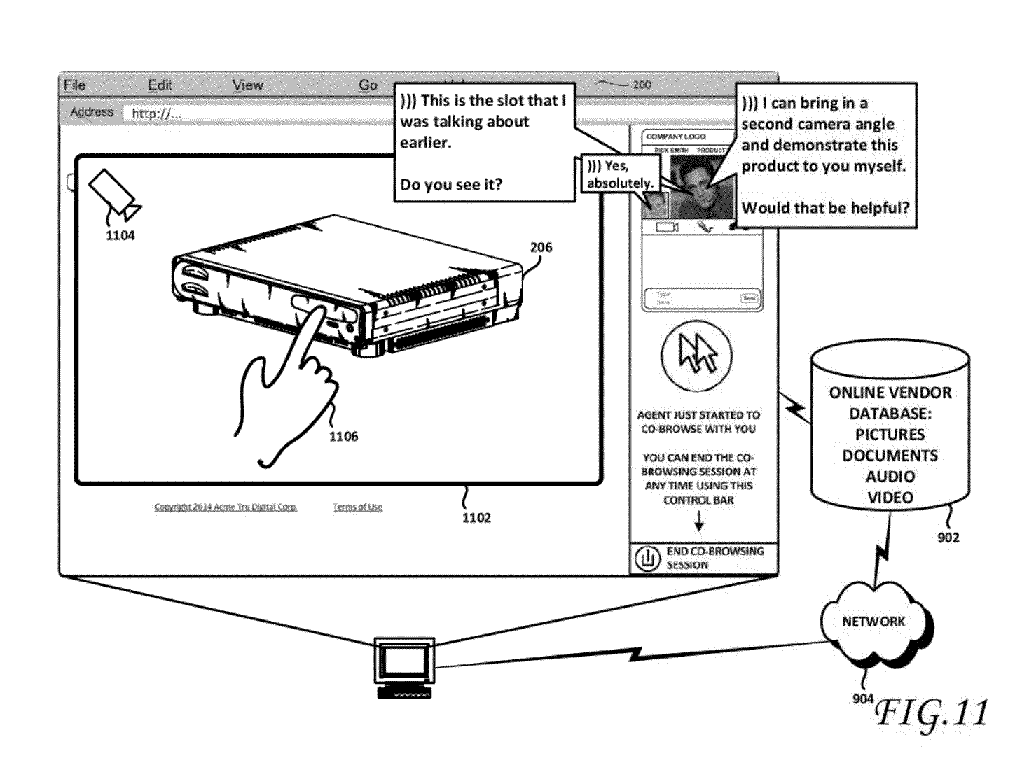

According to one embodiment, one or more second webcams may be brought online by the customer service representative and the video stream output 1102 therefrom rendered by the customer's browser within or overlaid on the vendor's webpage currently viewed by the customer, as shown in FIG. 11. As shown therein, the second webcam (a representation of which may be generated at 1104) may be angled differently than the webcam showing the customer service representative. For example, the second webcam(s) may show the customer service representative's desk and his or her hands 1106. Such a second webcam 1104 may enable the customer service representative to physically manipulate demonstrate use of a product (such as DVR 206 in this example) on camera while keeping eye contact with the customer via the primary video conferencing camera. According to one embodiment, the customer service representative may flip between cameras to conduct demonstrations of a product and then seamlessly switch back to the primary camera. Both cameras may be active at the same time. More than two camera feeds may readily be accommodated, as those of skill in this art may recognize.

According to one embodiment, the customer may resize, maximize or minimize the frame or window in which the second camera feed is being rendered. The customer service representative, the customer or both may be enabled to turn off the second camera at will. A high-bandwidth connection between the customer service representative and the customer is useful in this mode, to minimize the effects of latency during live demonstrations. As may be appreciated, such screen-sharing may have significant applications in a technical service environment.

According to one embodiment, when specific videos are displayed or document provided, a unique universal resource locator (“url”) link may be inserted into the text chat window, thereby enabling the customer to return to the video after the session has ended. According to one embodiment, the text of his or her conversation with the customer service representative may be provided to the customer after the communication session as endedby, for example, email. The transcript and url enables the customer to find the video(s) or document(s) on their own. Such transcripts, as comprising a record of all conversations during the session, may be archived by the online vendor for future reference and accountability, and to build and maintain their customer database. According to one embodiment, the customer service representative may be provided with the ability to take notes during chats and to save these notes to enable the online vendor to build customer profiles and to maintain their CRM software. Such record keeping enables feedback for training and customer service representative development purposes, ensures that customers are getting correct and timely answers to their questions and are receiving the best possible customer service from the online vendor's representative. According to one embodiment, customer details and notes from prior interactions with the customer may be imported from the online vendor's CRM database, such that they are available to the customer service representative prior to and during online chats and videoconferences. According to one embodiment, various communications tools may be integrated within one single transcript; the text exchanges (such as e-mail address or order number), the pushed documents, links (URLs) to the pushed media content as well as the activation of the co-control mode. Consequently, embodiments provide a very simple and intuitive user interface for the customer, who always knows where to look or click to control and exchange. Similarly, embodiments may also provide an integrated transcript that operates as a single source of information comprising all exchanged materials and texts sent to the customer. Such an integrated transcript may be sent or otherwise provided to the customer upon request—and/or archived by the vendor. According to one embodiment, the integrated transcript may be provided to the customer, via email (for example) when the customer provides his or her email to the customer service representative at the end or during the conversation. The integrated transcript may also include a list of pages co-visited with the agent, thereby enabling the customer to return to the site and retrace his or her steps. This may increase the likelihood that an initially undecided customer may return to the site and make a purchase.

The customer, according to one embodiment, may be prompted to provide the online vendor with their personal information, such as name, email, and reason for contact prior to engaging in a call. This information may be instrumental in enabling the customer service representative to customize the sales experience to each visiting customer depending the information provided and/or their specific inquiry. Such a pre-chat form may also ensure an unexpectedly disconnected call may be resumed by the customer service representative in a follow up call or email. One embodiment enables chat transcripts and customer details collected before, during or after discussions to be exported into the online vendor's CRM database.

According to one embodiment, after a call concludes, the customer may be requested to complete a basic web-user satisfaction survey. The feedback collected from these surveys may be used to improve the service delivered through customer—customer service representative interactions, improve customer acquisition and retention and drive revenue. According to one embodiment, the customer's purchases or lack thereof may be tracked for a predetermined period of time after a communication session, so as to enable reporting and revenue metrics to be applied, to objectively gauge the effectiveness of the customer service representative, for example.

According to one embodiment, the customer service representative may be notified when a customer has requested a communications session. If queuing is implemented, the customer service representative may be provided information detailing how many customers are waiting in queue for a communication session. Upon being so notified, the customer service representative, if immediately available, clicks a button to “accept” the communication session. The customer service representative may be provided with the customer's IP address and any other information that may be available, such as city/state, company name, and the like. The customer service representative may also, according to one embodiment, be provided with the metadata of one or more previous communication sessions including, for example, browser info, current page, referrer, IP address, geographic area. During the communication session, the customer service representative may share specific video and document files from an approved library only, such as shown at 902. For persons that have, through past behavior, proven themselves to be abusive or otherwise undesirable, the customer service representative may add the customer to a blacklist, to ban that customer from further interactions. Moreover, the customer service representative and/or the customer may disconnect (end) the communication session at any time for any reason.

If the communication session is unexpectedly interrupted, the customer may be sent the option to immediately re-engage with the same customer service representative via video chat or the previously used communication mode (e. g., text chat, audio only or video). A message may be displayed to the customer if their previous customer service representative is otherwise occupied and the customer may be invited to wait or to initiate a communication session with another customer service representative. A Web-user Service and Support (CSS) may be provided, to create canned messaging/templates available for use by customer service representatives. A detailed record of each customer interaction may be kept and archived including, for example, transcripts, screen shots, co-browsing details, which videos and/or documents were pushed, duration of interaction, among other possible items of information. Accordingly, operational metrics report (including, for example, session transcripts, chat length, average wait time, agent utilization, number of sessions, CPE, AHT, speed to answer) may be generated and archived by customer service representative, vendor, and site. Such data may be exported to, for example, Excel for review and quality purposes. Other performance metrics, such as chats provided, chats initiated, chats connected, chats completed, chats converted, revenue per communication session, items per basket in session, contribution margin in session, among other possibilities, may be collected and stored for later retrieval and analysis. Indeed, according to one embodiment, session data (including, for example, text chat messages, information detailing the customer's hardware (webcam, microphone, etc.) and detailing the customer's software (operating system, browser, etc.) may be recorded in real-time and stored in a session record within a .csv (according to one implementation) file. Exports of the .csv file may then be delivered to the IT department of the vendor or other organization handling the vendor's back office.

The maximum response time for a customer service representative to respond to a request for a communication session from a customer may be set to a predetermined value such as, for example, 15 seconds, except for agreed to exclusions. Response time may be defined as the time elapsed after the customer initiating a communication session (by clicking a Live chat button, for example) until the customer can see and hear the customer service representative.

According to one embodiment, the functionality described herein may be provided as a software as a service (SaaS) architecture that operates in a cloud environment. Multi-level security and controls may be provided to ensure the confidentiality and safeguarding of customer information and ensure a controlled access to system functions and features. Access to predetermined areas and functionality of the application may be controlled, according to one embodiment, based on system function to be performed. For security purposes, the communication channel with the customer service representative may be secured (e.g., a secure socket layer (SSL) and encryption) to prevent interception thereof by interlopers. Alternatively, a Real Time Messaging Protocol (RTMP) may be used, such as RTMPE, which is an Adobe variant of the RTMP protocol that utilizes s a 128-bit encrypted channel for data between client and the server. RTMPE does not use certificate management and is well suited for applications that do not require endpoint authentication and that require more performance and speed than is possible with SSL. To specify an encrypted channel, the RTMPE protocol may be utilized in the connection URI in the form, for example, nc.connect (“rtmpe://www.example.com/mediaapplication”). For voice and video media flows, for example, the Flash protocol may be implemented, enabling encryption with RTMPE, a Flash proprietary security solution using standard cryptography primitives, and RTMPs over a TLS/SSL connection protocols.

Text chats and internal communications may be protected via https encryption. Other protocols such as RTMPS (a protocol for enabling secure communications over TCP/IP) may be used. According to one embodiment, to specify an RTMPS connection, the RTMPS protocol may be used in the connect URI, and the following syntax may be employed: uc.connect (“rtmps://www.example.com/mediaapplication”). Data passed over RTMPS is protected by SSL guarantees. The RTMFP protocol, which uses 128-bit encryption, may also be used. Data passed over RTMFP is encrypted with the well-known block cipher encryption algorithm. The algorithm may be keyed using a well-known public-key-exchange algorithm, which prevents passive observation and provides perfect forward secrecy. Session nonces are provided and are tied to the key exchange, thereby enabling client and server authentication to be built on top of the exchanged values. To establish a peer-to-peer connection, a subscribing peer must know the peer ID of a publishing peer. These peer IDs are guaranteed to be unique for each instance of Flash Player. Peer IDs may be configured as 256 bit values created from a cryptographically random source. When an RTMFP peer connects to another RTMFP peer using a peer ID, the public-key-exchange algorithm is tied to the peer ID so that it is not possible to conduct a man-in-the-middle attack. To specify an RTMFP connection, the RTMFP protocol in the connect URI may be used with a format of for example: nc.connect (“rtmfp://www.example.com/mediaapplication”).

According to one embodiment, the structures and functionalities disclosed herein may be distributed across one or more servers. For example, such server(s) may be configured to comprise or support a Flash communications engine, a customer and customer service representative communication management engine(s), a co-browsing and screen-sharing engine(s), a development and software storage server, one or more media library servers, one or more WebRTC communication engines, one or more storage servers for communication session data and one or more servers and engines for front and back office functionalities. Other implementations are possible, as those of skill in this art may recognize. Some or all of these functionalities may be served by a same server or the functionalities may be distributed across geographically or co-located separate servers.

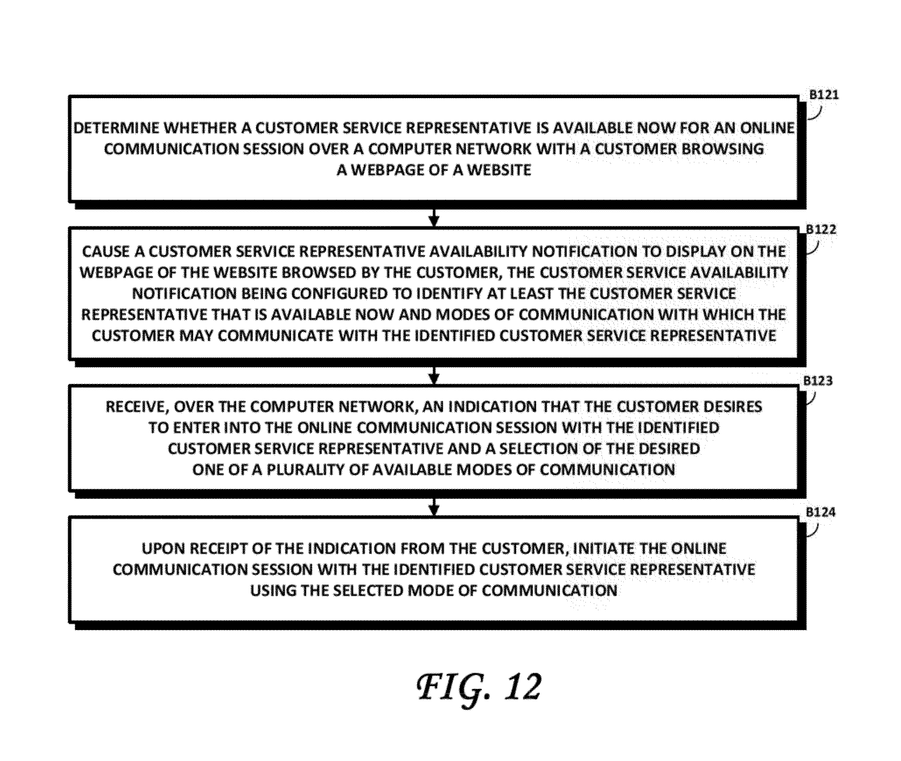

FIG. 12 is a flowchart of a method according to one embodiment. As shown therein, block B121 calls for determining whether a customer service representative is available now for an online communication session over a computer network with a customer browsing a webpage of a website. As shown at block B122, the customer service availability notification(s) may then be caused to be displayed on the webpage of the website browsed by the customer. According to one embodiment, the customer service availability notification may be configured to identify, among possible other items, the customer service representative that is available now and modes of communication with which the customer may communicate with the identified customer service representative. An indication that the customer desires to enter into the online communication session with the identified customer service representative may then be received over the computer network, as may be a selection of a desired one of a plurality of available modes of communication, as called for by block B123. Lastly, as show at B124, upon receiving the indication from the customer, the online communication session with the identified customer service representative may be initiated using the selected mode of communication.

Significantly, according to embodiments, customer service representatives may be available in real time, and may appear to customer as being available only when they are, in fact, available. According to one embodiment, as customer service availability notifications 210 are only displayed to the customer when there are, in fact, customer service representatives available, customers are not given the opportunity to place their name in a queue, as no such queue may be available. It is to be understood, however, that a queued implementation is possible and in no way incompatible with the other structures and functionalities shown and described herein. According to further embodiments and to minimize customer service representative's down-time, customer service representatives may be made available on several websites, using only the present single interface. Similarly, several interaction channels may be made available to the customer service representatives, who may be given some freedom in selecting which communication mode to expose to the customer such as, for example, text, audio or video chat.

Customer service representatives may save the most commonly used scripts and messages for instant retrieval during a communication session such as, for example, “Hi! How may I help you today?” Multi-lingual support may be readily implemented. According to one embodiment, audio and/or video chat, based on WebRTC and Flash technologies, enable customer service representatives to communicate with customers in a manner that is similar to the manner in which a flesh and blood store clerk or fashion consultant would interact with a customer in a real, physical store or boutique. Comprehensive support for the most common mobile devices extends the reach of the present embodiments. The acquisition and archiving of CRM data enables customer service representatives to access the conversation history of high-value customers to better serve them. The collection of other data associated with customer contacts drives website and communication session analytics, which may lead to improved customer service. Data associated with communication sessions may be configured to be automatically transferred to a CRM tool. By storing customer service representatives notes prior to, during and after communication sessions enables later recovery and analysis thereof.

Messaging functionality may be implemented, to allow customers to leave a message when no customer service representatives are available. Advantageously, customer service representative availability notifications may be configured, according to one embodiment, to appear only when predetermined criteria are met, such as registered customer, time spent on a page, the total value of the items placed in a shopping cart, and the like.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method, comprising:
determining whether a customer service representative is available now for an online communication session over a computer network with a customer browsing a webpage of a website;
causing a customer service availability notification to display on the webpage of the website browsed by the customer, the customer service availability notification being configured to identify at least the customer service representative that is available now and modes of communication with which the customer may communicate with the identified customer service representative;
receiving, over the computer network, an indication that the customer desires to enter into the online communication session with the identified customer service representative and a selection of a desired one of a plurality of available modes of communication; and
upon receiving the indication from the customer, initiating the online communication session with the identified customer service representative using the selected mode of communication.

2. The method of claim 1, wherein initiating the online communication session is carried out without placing the customer in a queue waiting the identified customer service representative to become available.

3. The method of claim 1, wherein the plurality of modes of communication comprise text chat, audio, full duplex video and one-way video with the identified customer service representative.

4. The method of claim 3, further comprising switching the initiated online communication session from one of the plurality of modes of communication to another one of the plurality of modes of communication.

5. The method of claim 4, wherein switching is carried out without action from customer.

6. The method of claim 3, wherein the text chat mode of communication remains available during an audio only, full duplex and one-way video communication session.

7. The method of claim 1, further comprising selecting media from a media library and pushing the selected media over the computer network for viewing by the customer while maintaining the online communication session with the customer using the selected mode of communication.

8. The method of claim 7, wherein the media comprises a video.

9. The method of claim 8, further comprising providing the customer with a link to the video.

10. The method of claim 7, wherein the media comprises an electronic document.

11. The method of claim 10, further comprising providing the electronic document to the customer.

12. The method of claim 1, further comprising causing a notification of a number of customer service representatives that are available now for an online communication session with the customer to be displayed to the customer.

13. The method of claim 1, wherein the customer service availability notification further comprises a picture of the customer service representative that is available now.

14. The method of claim 1, wherein the customer service availability notification further comprises at least one of a title of the identified customer service representative, languages spoken by the identified customer service representative and an expertise of the identified customer service representative.

15. The method of claim 1, wherein determining comprises detecting whether the customer service representative is a) currently physically present at his or her workstation and b) available now for the online communication session with the customer.

16. The method of claim 15, further comprising causing a previously-displayed customer service availability notification to be removed from view of the customer if the customer service representative is determined to not be currently physically present at his or her workstation or is not available now for the online communication session with the customer.

17. The method of claim 1, further comprising one of co-browsing and screen with the customer during the online communication with the customer using the selected mode of communication.

18. The method of claim 1, further comprising enabling the identified customer service representative to selectively highlight a portion of the webpage currently viewed by the customer.

19. The method of claim 1, further comprising, during a live video communication session between the customer and the identified customer service representative using a first camera, activating a second camera and a second live video feed and causing the second live video feed to be displayed on the webpage currently viewed by the customer.

20. The method of claim 1, wherein the second camera is pointed to the hands of the customer service representative, thereby enabling the identified customer service representative to physically manipulate and demonstrate a product to the customer during the live video session with the customer.

21. The method of claim 1, further comprising generating and providing a transcript of the online communication session.

22. A method, comprising:
displaying a website accessible over a computer network using a browser;
displaying, on the browser, a customer service availability notification, the customer service availability notification identifying at least a customer service representative that is available now for an online communication session and a plurality of available modes of communication with which the communication session with the identified customer service representative may be initiated;
initiating the online communication session with the identified customer service representative by sending, over the computer network, a first signal that is indicative of a selected customer service availability notification and a desired one of the plurality of available modes of communication; and
enabling the online communication session to be carried out with the identified customer service representative using the selected mode of communication while continuing to display and enable browsing of the website.

23. The method of claim 22, wherein initiating the online communication session is carried out without being placed in a queue waiting for the identified customer service representative to become available.

24. The method of claim 22, wherein the plurality of modes of communication comprise text chat, audio, full duplex video and one-way video with the identified customer service representative.

25. The method of claim 24, further comprising switching from one of the plurality of available modes of communication to another one of the plurality of available modes of communication.

26. The method of claim 25, wherein switching is carried out without action from customer

27. The method of claim 24, wherein the text chat mode of communication remains available during an audio only, full duplex and one-way video communication session.

28. The method of claim 22, further comprising sending, over the computer network, a second signal that is indicative of an agreement for selected media from a media library to be pushed to the browser over the computer network while maintaining the online communication session with the identified customer service representative using the selected mode of communication.

29. The method of claim 28, wherein the media comprises a video.

30. The method of claim 29, further comprising receiving a link to the video.

31. The method of claim 28, wherein the media comprises an electronic document.

32. The method of claim 31, further comprising one of receiving and downloading the electronic document.

33. The method of claim 22, further comprising receiving a notification of a number of identified customer service representatives that are available now for an online communication session.

34. The method of claim 22, wherein the customer service availability notification further comprises a picture of the customer service representative that is available now.

35. The method of claim 22, wherein the customer service availability notification further comprises at least one of a title of the identified customer service representative, languages spoken by the identified customer service representative and an expertise of the identified customer service representative.

36. The method of claim 22, wherein the customer service representative availability notification is only displayed on the browser when the customer service representative is a) currently physically present at his or her workstation and b) available now for the online communication session.

37. The method of claim 36, further comprising removing a previously-displayed customer service availability notification from the browser if the identified customer service representative is determined to not be currently physically present at his or her workstation or is not available now for the online communication session with the customer.

38. The method of claim 22, further comprising one of co-browsing and screen with the identified customer service representative during the online communication with the identified customer service representative using the selected mode of communication.

39. The method of claim 22, further comprising selectively highlighting a portion of the webpage currently displayed by the browser in response to actions from the identified customer service representative.

40. The method of claim 22, further comprising, during a live video communication session with the identified customer service representative using a first camera aimed at the identified customer service representative, the browser displaying a second live video feed and causing the second live video feed to be displayed on the browser.

41. The method of claim 40, wherein the second camera is pointed to the hands of the customer service representative, thereby enabling the browser to display the identified customer service representative physically manipulating and demonstrating a product during the live video session.
